(19) United States
(12) Patent Application Publication
(10) Pub. No.: US 2002/0118890 A1
(43) Pub. Date: Aug. 29, 2002

(54) Method and apparatus for processing photographic images

(76) Inventor: Michael Rondinelli, Bethel Park, PA (US)

Correspondence Address: Robert P. Lenart, Pietragallo, Bosick & Gordon, One Oxford Centre, 38th Floor, 301 Grant Street, Pittsburgh, PA, 15219, US

(21) Appl. No.: 10/081,545

(22) Filed: Feb. 22, 2002

Related U.S. Application Data
(60) Provisional application No. 60/315,744, filed on Aug. 29, 2001.
(60) Provisional application No. 60/271,154, filed on Feb. 24, 2001.

(51) Int. Cl. G06K 9/36

(52) U.S. Cl. 382/276

(57) ABSTRACT

A method of processing images includes the steps of retrieving a source image file including pixel data, creating a destination image file buffer, mapping the pixel data from the source image file to the destination image file buffer, and outputting pixel data from the destination image file buffer as a destination image file. The step of mapping pixel data from the source image file to the destination image file buffer can include the step of interpolating the source image pixel data to produce pixel data for the destination image file buffer. The step of mapping pixel data from the source image file to the destination image file buffer can include the step of interpolating the source image pixel data to produce pixel data for the destination image file buffer. Border pixel data can be added to the source image file to improve the efficiency interpolation step. The source image file can be a panoramic projection image file, and can include pixel data from a plurality of images. An apparatus for processing images in accordance with the method is also provided.

### CROSS-REFERENCE TO RELATED APPLICATIONS

This application claims the benefit of U.S. Provisional Application Serial No. 60/315,744 filed Aug. 29, 2001, and U.S. Provisional Application Serial No. 60/271,154 filed Feb. 24, 2001.

### FIELD OF THE INVENTION

The present invention relates to methods and apparatus for processing photographic images, and more particularly to methods and apparatus for making the images more suitable for viewing.

### BACKGROUND INFORMATION

Recent work has shown the benefits of panoramic imaging, which is able to capture a large azimuth view with a significant elevation angle. If instead of providing a small conic section of a view, a camera could capture an entire half-sphere at once, several advantages could be realized. Specifically, if the entire environment is visible at the same time, it is not necessary to move the camera to fixate on an object of interest or to perform exploratory camera movements. This also means that it is not necessary to actively counteract the torques resulting from actuator motion. Processing global images of the environment is less likely to be affected by regions of the image that contain poor information. Generally, the wider the field of view, the more robust the image processing will be.

Some panoramic camera systems capture light from all directions (i.e., 360 degrees in a given plane), either as still images or as a continuous video stream. The images from such a device can be geometrically transformed to synthesize a conventional camera view in any direction. One method for constructing such panoramic camera systems combines a curved mirror and an imaging device, such as a still camera or video camera. The mirror gathers light from all directions and re-directs it to the camera. Both spherical and parabolic mirrors have been used in panoramic imaging systems.

Numerous examples of such systems have been described in the literature. For example, U.S. Pat. No. 6,118,474 by Nayar discloses a panoramic imaging system that uses a parabolic mirror and an orthographic lens for producing perspective images. U.S. Pat. No. 5,657,073 by Henley discloses a panoramic imaging system with distortion correction and a selectable field of view using multiple cameras, image stitching, and a pan-tilt-rotation-zoom controller.

Ollis, Herman, and Singh, “Analysis and Design of Panoramic Stereo Vision Using Equi-Angular Pixel Cameras”, CMU-RI-TR-99-04, Technical Report, Robotics Institute, Carnegie Mellon University, January 1999, discloses a camera system that includes an equi-angular mirror that is specifically shaped to account for the perspective effect a camera lens adds when it is combined with such a mirror.

Raw panoramic images produced by such camera systems are typically not suitable for viewing. Thus there is a need for a method and apparatus that can make such images more suitable for viewing.

### SUMMARY OF THE INVENTION

This invention provides a method of processing images including the steps of retrieving a source image file including pixel data, creating a destination image file buffer, mapping the pixel data from the source image file to the destination image file buffer, and outputting pixel data from the destination image file buffer as a destination image file. The step of mapping pixel data from the source image file to the destination image file buffer can include the steps of defining a first set of coordinates of pixels in the destination image file, defining a second set of coordinates of pixels in the source image file, identifying coordinates of the second set that correspond to coordinates of the first set, inserting pixel data for pixel locations corresponding the first set of coordinates into corresponding pixel locations corresponding to the second set of coordinates.

The first set of coordinates can be spherical coordinates and the second set of coordinates can be rectangular coordinates. The source image file can be a two dimensional set of source image pixel data, containing alpha, red, blue and green image data.

The step of mapping pixel data from the source image file to the destination image file buffer can include the step of interpolating the source image pixel data to produce pixel data for the destination image file buffer. Border pixel data can be added to the source image file to improve the efficiency interpolation step.

The source image file can be a panoramic projection image file, and can include pixel data from a plurality of images. The destination image file can be any of several projections, including a cylindrical panoramic projection image file, a perspective panoramic projection image file, an equirectangular panoramic projection image file, and an equiangular panoramic projection image file.

The invention also encompasses an apparatus for processing images including means for receiving a source image file including pixel information; a processor for creating a destination image file buffer, for mapping the pixel data from the source image file to the destination image file buffer; and for outputting pixel data from the destination image file buffer as a destination image file, and means for displaying an image defined by the destination file.

The processor can further serve as means for defining a first set of coordinates of pixels in the destination image file, defining a second set of coordinates of pixels in the source image file, identifying coordinates of the second set that correspond to coordinates of the first set, and inserting pixel data for pixel locations corresponding the first set of coordinates into pixel locations corresponding to the second set of coordinates.

The processor can further serve as means for interpolating the source image pixel data to produce pixel data for the destination image file buffer.

### BRIEF DESCRIPTION OF THE DRAWINGS

FIG. 1 is a schematic representation of a system for producing panoramic images that can utilize the invention;

FIG. 2 is a functional block diagram that illustrates the interface and job functions of software that can be used to practice the method of the invention;

FIG. 3 is a functional block diagram that illustrates the PhotoWarp functions of software that can be used to practice the method of the invention;

FIG. 4 is a functional block diagram that illustrates the output functions of software that can be used to practice the method of the invention; and

FIG. 5 is a flow diagram that illustrates a particular example of the method of the invention.

### DETAILED DESCRIPTION OF THE INVENTION

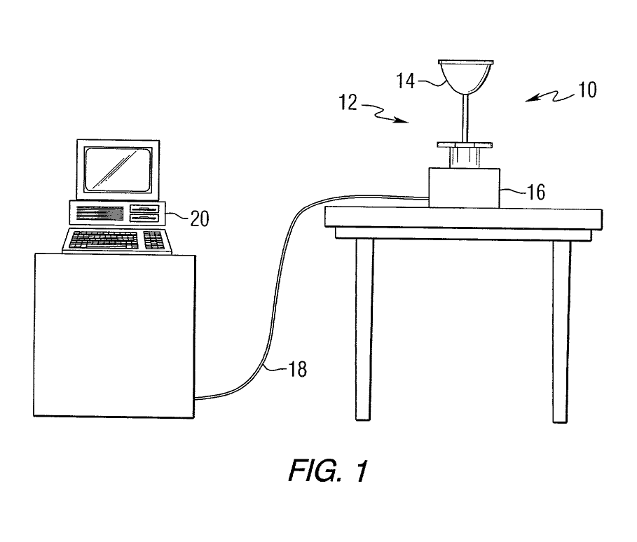

The present invention provides a method and apparatus for processing images represented in electronic form. Referring to the drawings, FIG. 1 is a schematic representation of a system 10 for producing panoramic images that can utilize the invention. The system includes a panoramic imaging device 12, which can be a panoramic camera system as disclosed in U.S. Provisional Application Serial No. 60/271,154 filed Feb. 24, 2001, and a commonly owned United States Patent Application titled “Improved Panoramic Mirror And System For Producing Enhanced Panoramic Images”, filed on the same date as this application and hereby incorporated by reference. The panoramic imaging device 12 can include an equiangular mirror 14 and a camera 16 that cooperate to produce an image in the form of a two-dimensional array of pixels. For the purposes of this invention, the pixels are considered to be an abstract data type to allow for the large variety of color models, encodings and bit depths. Each pixel can be represented as a data word, for example a pixel can be a 32-bit value consisting of four 8-bit channels: representing alpha, red, green and blue information. The image data can be transferred, for example by way of a cable 18 or wireless link, to a computer 20 for processing in accordance with this invention.

The method of the invention is performed using a software application, hereinafter called PhotoWarp, that can be used on various types of computers, such as Mac OS 9, Mac OS X, and Windows platforms. The invention is particularly applicable to processing panoramic images created using panoramic optic camera systems. The software can process images shot with panoramic optic systems and produce panoramic images suitable for viewing. The resulting panoramas can be produced in several formats, including flat image files (using several projections), QuickTime VR movies (both cylindrical and cubic panorama format), and others.

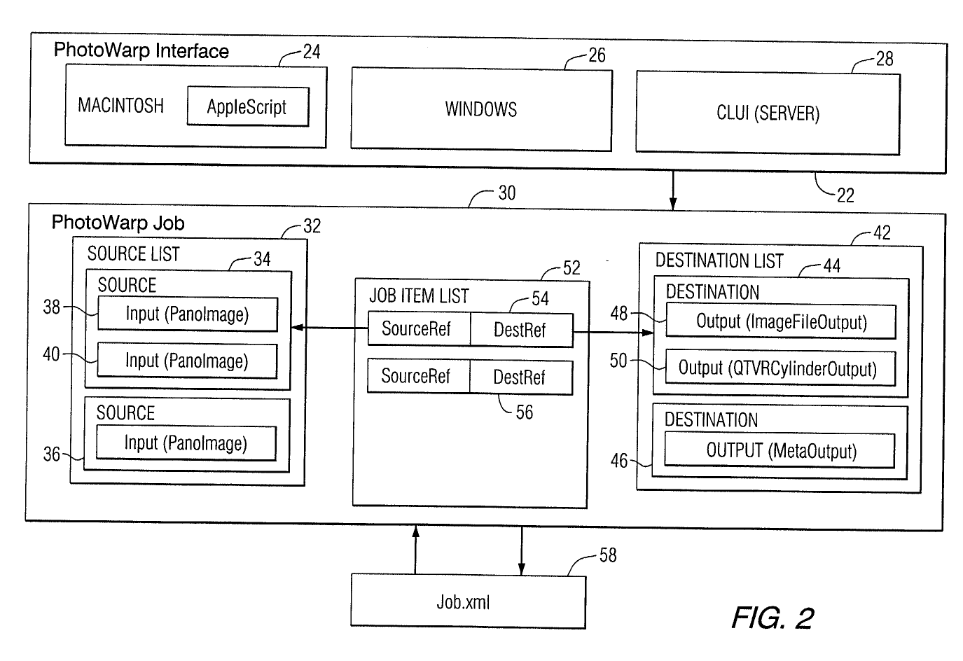

FIG. 2 is a functional block diagram that illustrates the interface and job functions of software that can be used to practice the method of the invention. Block 22 shows that the interface can to operate in Macintosh 24, Windows 26, and server 28 environments. A user uses the interface to input information to create a Job that reflects the user's preferences concerning the format of the output data. User preferences can be supplied using any of several known techniques including keyboard entries, or more preferably, a graphical user interface that permits the user to select particular parts of a raw image that are to be translated into a form more suitable for viewing.

The PhotoWarp Job 30 contains a source list 32 that identifies one or more source image groups, for example 34 and 36. The source image groups can contain multiple input files as shown in blocks 38 and 40. The PhotoWarp Job 30 also contains a destination list 42 that identifies one or more destination groups 44 and 46. The destination groups can contain multiple output files as shown in blocks 48 and 50. A Job item list 52 identifies the image transformation operations that are to be performed, as illustrated by blocks 54 and 56. The PhotoWarp Job can be converted to XML or alternatively created in XML as shown by block 58.

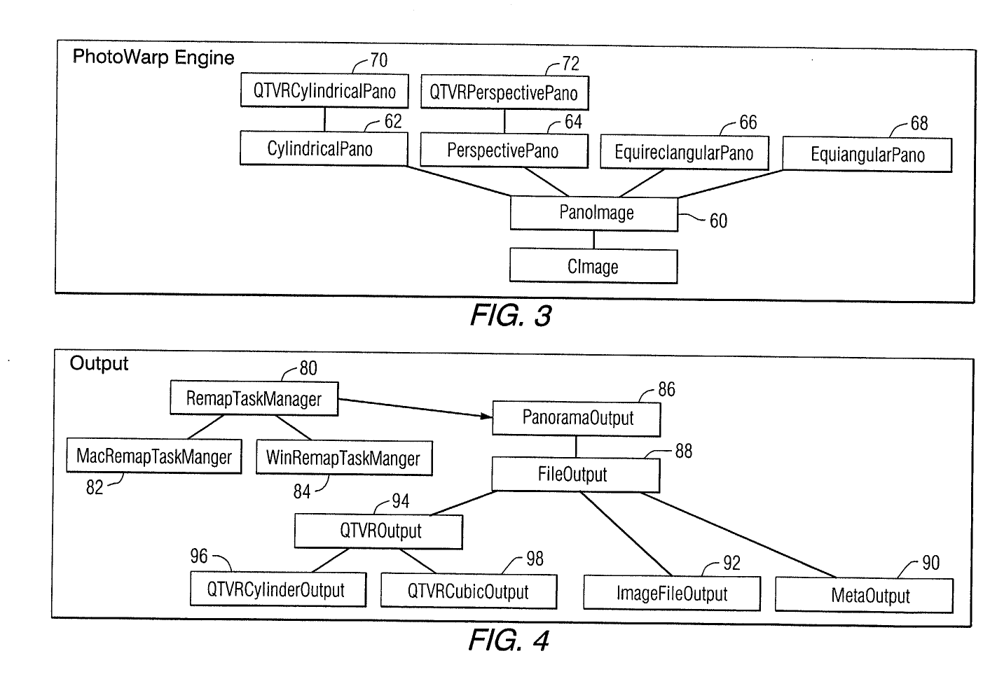

FIG. 3 is a functional block diagram that illustrates several output image options that can be used when practicing the method of the invention. The desired output image is referred to as a PanoImage. The PanoImage 60 can be one of many projections, including Cylindrical Panoramic 62, Perspective Panoramic 64, Equirectangular Panoramic 66, or Equiangular Panoramic 68. The Cylindrical Panoramic projection can be a QTVR Cylindrical Panoramic 70 and the Perspective Panoramic projection can be a QTVR Perspective Panoramic 72. The PanoImage is preferably a CImage class image as shown in block 74. Alternatively, the PanoImage can contain a CImage, but not itself be a CImage.

FIG. 4 is a functional block diagram that illustrates the output functions that can be used in the method of the invention. A Remap Task Manager 80, which can be operated in a Macintosh or Windows environment as shown by blocks 82 and 84 controls the panorama output in block 86. The panorama output is subsequently converted to a file output 88 that can be in one of several formats, for example MetaOutput 90, Image File Output 92 or QTVR Output 94. Blocks 96 and 98 show that the QTVR Output can be a QTVR Cylindrical Output or a QTVR Cubic Output.

The preferred embodiment of the software includes a PhotoWarp Core that serves as a cross-platform “engine” which drives the functionality of PhotoWarp. The PhotoWarp Core handles all the processing tasks of PhotoWarp, including the reprojection or “unwarping” process that is central to the application's function.

PhotoWarp preferably uses a layered structure that maximizes code reuse, cross-platform functionality and expandability. The preferred embodiment of the software is written in the C and C++ languages, and uses many object-oriented methodologies. The main layers of the application are the interface, jobs, a remapping engine, and output tasks.

The PhotoWarp Core refers to the combination of the Remapping Engine, Output Tasks, and the Job Processor that together do the work of the application. The interface allows users to access this functionality.

The Remapping Engine, or simply the “Engine” is an object-oriented construct designed to perform arbitrary transformations between well-defined geometric projections. The Engine was designed to be platform independent, conforming to the ANSI C++ specification and using only C and C++ standard library functions. The Engine's basic construct is an image object, represented as an object of the CImage class. An image is simply a two-dimensional array of pixels. Pixels are considered to be an abstract data type to allow for the large variety of color models, encodings and bit depths. In one example, a Pixel is a 32-bit value consisting of four 8-bit channels: alpha, red, green and blue.

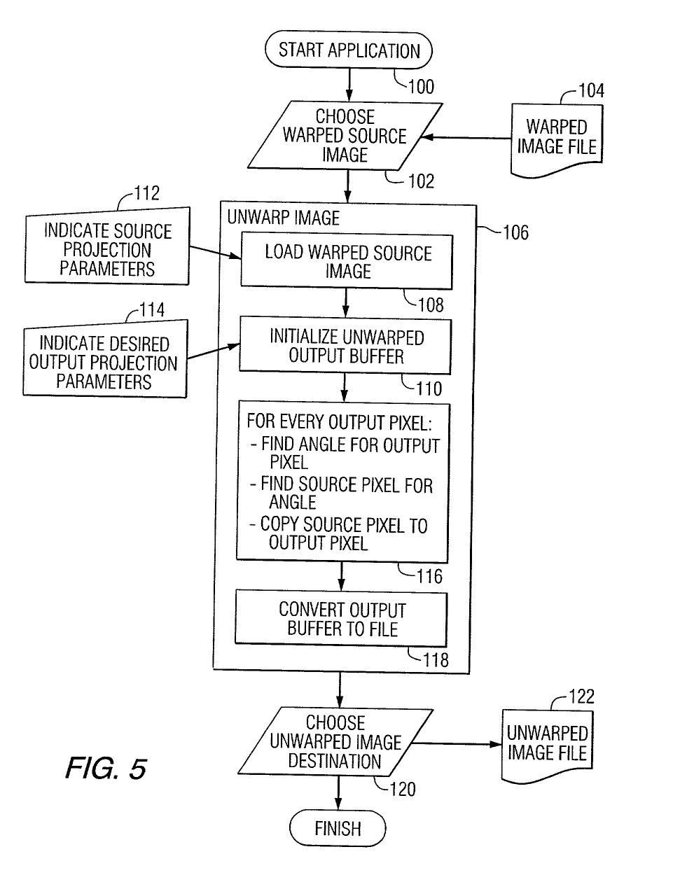

FIG. 5 is a flow diagram that illustrates a particular example of the method of the invention. At the start of the process, as illustrated in block 100, a warped source image is chosen as shown in block 102 from a warped image file 104. Several processes are performed to unwarp the image as shown in block 106. In particular, block 108 shows that the warped image is loaded into a buffer. The warped image buffer then includes source file pixel information and predetermined or user-specified metadata that identifies the source image projection parameters. An unwarped output image buffer is initialized as shown in block 110. The desired output projection parameters are indicated as shown in block 114. Block 116 shows that for every output pixel, the method determines the angle for the output pixel and the corresponding source pixel for the angle. The angle can be represented as theta and phi, which are polar coordinates. The radius will always be one for spherical coordinates, since these images contain no depth information. Then the source pixel value is copied to the output pixel. After all output pixels have received a value, the output buffer is converted to an output file as shown in block 118. An unwarped image destination is chosen as shown in block 120 and the unwarped image file is loaded into the chosen destination as shown in block 122.

Using the described process, the warped source image can be converted into an image with a more traditional projection using an unwarping process. For example, it may be desirable to unwarp an equiangular source image into an equirectangular projection image, where pixels in the horizontal direction are directly proportional to the pan (longitudinal) angles (in degrees) of the panorama, and pixels in the vertical direction are directly proportional to the tilt (latitudinal) angles (also in degrees) of the panorama.

The algorithm for the unwarping process determines the one-to-one mapping between pixels in the unwarped image and those in the warped image, then uses this mapping to extract pixels from the warped image and to place those pixels in the unwarped image, possibly using an interpolation algorithm for smoothness. Since the mapping between the unwarped and warped images may not translate into integer coordinates in the source image space, it may be necessary to determine a value for pixels in between other pixels. Bi-directional interpolation algorithms (such as bilinear, bicubic, spline, or sinc functions) can be used to determine such values.

The dimensions of the output image can be chosen independently of the resolution of the source image. Scaling can be achieved by interpolating the source pixels. Pixels in the warped source will be unwrapped and stretched to fill the desired dimensions of the output image.

The flow diagram of FIG. 5 illustrates one algorithm for the unwarping process. For each pixel in the output image, a unique pan/tilt coordinate is determined which uniquely identifies a ray in the scene. Where all image projections are two-dimensional and assumed to be taken from the same camera focal point, rays are emitted from the origin of a unit sphere. Then using a model of an equiangular image projection, the pixel radius is determined for the tilt coordinate. The pixel of interest in the source image is then determined by multiplying the radius by the cosine of the pan angle, then adding the horizontal pixel offset of the mirror center for the horizontal direction, and multiplying the radius by the sine of the pan angle, then adding the vertical pixel offset of the mirror center for the vertical direction.

SourceX=radius*cos(pan)+centerX

SourceY=radius*sin(pan)+centerY

Certain constants for the warped and unwarped images can be calculated in advance to simplify these calculations. For example, loop invariants can be calculated prior to entering a processing loop to save processing time. The pixel coordinates of the source and output images are defined in this example using standard Cartesian coordinates, with the origin at the lower left of the image.

To create an equirectangular projection image from an equiangular image source produced by a reflective mirror optic, the image and projection for the source equiangular image must first be defined. This can be accomplished by retrieving the source equiangular image, defining the center of the mirror in a horizontal direction (in pixels), defining the center of the mirror in a vertical direction (in pixels), determining the radius of the mirror (in pixels), determining the minimum vertical field of view for the mirror (in degrees), and determining the maximum vertical field of view for the mirror (in degrees). Next the number of pixels per degree in the radial direction is calculated for the equiangular image. An image produced by a reflective mirror panoramic camera system that uses an equiangular mirror is basically a polar, or circular, image with a center point, a given radius, and a minimum and maximum field of view. The equiangular angular mirror is designed so that the tilt angle varies linearly between the minimum and maximum, which allows the pre-computation of the pixels per degree. The number of pixels per degree is equal to the difference between the maximum pixel number in the source image and the minimum pixel number in the source image, then dividing by the radius of the source image. This value is used in the unwarping process.

An image buffer and projection for the output equirectangular image is then defined by specifying the desired width of output image (pixels), the desired height of output image (pixels), the desired minimum vertical field of view (degrees), and the desired maximum vertical field of view (degrees).

Next, the degrees per pixel in both the horizontal and vertical directions is calculated for the output image. The degrees per pixel in the horizontal direction is equal to 360° divided by the output image width in pixels and the degrees per pixel in the vertical direction is equal to the difference between the maximum pixel number in the output image and the minimum pixel number in the output image, divided by the height of the output image. This value is independent of the source resolution, and does not increase the amount of detail in the image beyond what is available in the source.

Next, each output pixel from the source image is determined. To accomplish this, the pan and tilt angles corresponding to each output pixel are determined. Then the source pixel corresponding to this pan/tilt angle is located. Since the radius in pixels is known, the horizontal and vertical coordinates can be determined using trigonometry. For example, the horizontal location of the source pixel, sourceH, is equal to the horizontal center of the source pixel array (sourceImage.centerH), plus the source radius multiplied by the cosine of the pan angle (sourceR*cos(pan)), and the vertical location of the source pixel, sourceV, is equal to the vertical center of the source pixel array (sourceImage.centerV), plus the source radius times the sine of the pan angle (sourceR*sin(pan)). Next the source pixel from the determined coordinate is written into the output image buffer. Then the output image contains an equirectangular projection mapping of the source.

The CImage class is used to perform basic pixel operations on the image. A major operation used by the Core is a GetPixel( ) function, which retrieves a pixel value from an image using one of several possible interpolation algorithms. These algorithms include nearest neighbor, bilinear, bicubic, spline interpolation over 16, 36, or 64 pixels, and sinc interpolation over 256 or 1024 pixels. The higher interpolators achieve better quality and accuracy at the cost of processing speed. The type of interpolator used can be selected by the user, but is usually restricted to one of bilinear, bicubic and spline 16 or 36 for simplicity.

When allocating memory for an image loaded from a file, the CImage class creates a border for the image area that depends on the interpolator. This serves two purposes. First, when using the GetPixel( ) function on the edge of an image, an interpolator may require pixel data from outside the image boundary. Rather than testing for this condition on every call, the border is created that is sufficiently large to return valid pixels for the interpolator, returning either a constant color or repeating the nearest valid pixel value. Second, some panoramic image formats “wrap around” from one side to the image of another. If this is not accounted for during interpolation, distracting lines may appear when reprojecting. Therefore, “wrapped” images will have the last few pixels form one side of the image copied to the other side. This optimization significantly increases performance when retrieving pixels.

PanoImage is a subclass of CImage, or in simpler terms, a PanoImage “is” a CImage. The PanoImage class is abstract, defining the interface for performing transformations between projections, but not defining the projections themselves. This allows subclasses for each supported image projection format to be created without requiring any knowledge of any other formats. The PanoImage base class defines a generic Remap( ) function that performs transformations from any known projection to any other known projection. The Remap( ) function defines a point in Cartesian coordinates (h,v) that identifies a pixel in the destination buffer. Next, a panorama angle (panoramaAngle) for each point is determined. The panorama angle (q,f) uniquely identifies a point using spherical coordinates. Then a point in the source image (sourcePoint), representing the coordinates (h,v) of a point in the source panorama which corresponds to the same panoramaAngle, is defined. Finally the output pixel for the panoramaAngle point is set to the value of the corresponding source point pixel.

Remap( ) is a very simple function that performs transformations without any knowledge of either the source or destination projections. To function, it requires only that a specific projection implements the GetAngleForPoint( ) and GetPointForAngle( ) functions. These functions define the relationship between any point in an image of a specific projection and a point on a unit sphere.

GetAngleForPoint( ) takes two parameters inX and inY as inputs. These parameters define the point in the image plane of interest. The function then calculates the polar angles (in radians) corresponding to this image point and returns them in outTheta (longitude) and outPhi (latitude). GetAngleForPoint( ) returns a Boolean value indicating success (true) or failure (false) in the case where the point does not have a mapping or is not well defined. A class can return a failure each time the GetAngleForPoint( ) function is called, in which case it is not possible to use the projection as an output format.

GetPointForAngle( ) takes two parameters inTheta and inPhi as parameters (generated by GetAngleForPoint( ) from another projection), which define the longitude and latitude on a unit sphere, in radians. The projection must calculate the image coordinates corresponding to this spherical coordinate, and return them as outX and outY. GetPointForAngle( ) returns true on success, and false when no valid image point could be found, or when the mapping is not defined. A class can always return false, in which case it is not possible to use the projection as an input format.

In some cases it may be necessary to use several sources to produce a complete panoramic image. The most familiar example of this is traditional “stitching” methods for taking a series of photographs with a conventional field-of-view and combining them into a 360-degree panorama. A different version of the Remap( ) function is defined for these circumstances. In this version of Remap( ), every point in the image is initialized to a predetermined background color. The alpha component of a given pixel in an image is commonly used for composition of layers of images with variable transparency. PhotoWarp uses this alpha value to represent the opaqueness of a point in the image. Each destination file pixel initially has an alpha value of 0, indicating that no valid image data is available. Then for each source in sourceArray, the program cycles through the provided sources in order, and attempts to retrieve a pixel value from each. If a particular source does not have a corresponding pixel for this point, it will not increase the alpha value of the destination file pixel. If the source pixel is near the edge of the source, the alpha will be between 0 and 1, which allows the use of a composite of multiple sources. Once the alpha reaches 1.0, the destination pixel is fully defined. There is no need to get values from the remaining sources

In this manner, the PhotoWarp core is capable of composing any number of source images into a single panorama. This is considerably more flexible than a traditional “stitcher” composing process since it makes no assumptions about the format of each source image. It is possible that each source can have a completely different projection. For example, an image taken with a reflective mirror optic can be composited with a wide-angle fisheye lens to produce a full spherical panorama.

The PanoImage class has one other abstraction that is useful for panoramic images. The resolution of traditional digital images is identified by the number of pixels, or pixels per inch for printed material. This concept is ambiguous for panoramic images because the images are scaled and distorted in such a way that pixels and inches don't mean very much. A more consistent measurement of resolution for panoramic images is pixels per degree (or radian), which relates the pixel density of an image with its field of view. For a non-technical user, converting from pixels per degree to the number of pixels in a panorama can be complex, and varies between image projections. PanoImage solves this problem using abstract functions called GetPixelsPerRadian( ) and SetPixelsPerRadian( ). These functions are used to convert between standard pixels per degree/radian and the width and height of the image for the selected projection.

Each projection class implements the GetPixelsPerRadian( ) function and returns a value based on its image dimensions and projection settings. For example, a 360 degree cylindrical projection can calculate its resolution in pixels per radian by dividing its image width by 2π radians. SetPixelsPerRadian( ) is implemented in a similar fashion, adjusting the size of its image buffer to accommodate the desired resolution.

The end user is sheltered from the dimensions of the image and is presented with only meaningful resolution values. PanoImage includes much of the functionality of the remapping engine in surprisingly little code. But in order to function, it requires the definition of subclasses for each supported projection type.

In the preferred embodiment, several projections are built in to the PhotoWarp Core. The equiangular projection is typically used as the source panoramic image. It defines the parameters for unwarping images taken with a reflective mirror optic. The equiangular projection requires several parameters: the center point of the optic, the radius of the optic, and the field of view of the optic itself.

Cylindrical projections are commonly used for traditional QuickTime VR panoramas. The parameters are the limits of the vertical field of view, which must be greater than −90 degrees below the horizon and less than 90 degrees above the horizon due to the nature of the projection, which increases in height without bound as these limits are approached.

Equirectangular projections are also are a good format for image file output of panoramas. The result looks slightly more distorted than a cylindrical panorama, but can represent a vertical field of view from −90 degrees to 90 degrees.

Perspective projections are the most “normal” to the human eye. This projection approximates an image with a traditional rectilinear lens. It cannot represent a full panorama, unfortunately. The output of this projection is identical to that produced by the QuickTime VR renderer. Parameters for this projection are pan, tilt, and vertical field of view. An aspect ratio must also be provided.

QuickTime VR Cylindrical Projections are a subclass of the traditional cylindrical projection. The only difference is when setting the resolution, the dimensions of the cylindrical image are constrained according to the needs of a QuickTime VR cylindrical panorama.

QuickTime VR Perspective Projections are a subclass to the normal perspective projection. They are used to project each face of a QuickTime VR cubic panorama, subject to the dimensional constraints of that format. These constraints depend on the number of tiles used per face.

The engine has been designed with expandability in mind. For example, a software plug-in projection can be coded external to the application which define the functions GetPointForAngle( ), GetAngleForPoint, GetResolutionPPD( ), and SetResolutionPPD( ). The PhotoWarp Core can detect the presence of such plug-in projections and gain access to their functionality. The user interface can be updated to accommodate new projection formats.

The remapping engine provides the functionality necessary to perform the actual transformations of the application, but does not specify nor have any knowledge of file formats or the processing abilities of the host computer. Because these formats are independent of each projection, require non-ANSI application program interfaces (APIs) and may have platform-specific implementations, this functionality has been built into a layer on top of the Remapping Engine. The Output Manager specifies the details of output file formats, and works with a Task Manager to generate an output on a host platform.

PanoramaOutput is the abstract base class of the Output Managers. It implements a call through functionality to the Remapping Engine so higher layers in the PhotoWarp Core do not need explicit knowledge of the Remapping Engine to operate. Further, it can subdivide a single remapping operation into multiple non-overlapping segments. This allows the PhotoWarp Core to support multiple-processor computers or distributed processing across a network. In operating systems without preemptive multitasking, it also gives time back to the main process more frequently to prevent the computer from being “taken over” by the unwarping process. Not all output formats use the Remapping Engine. Because of this, PanoramaOutput does not assume that the main operation for an output is remapping. A Begin( ) function is called by the Output's constructor to begin the process of generating an output. Depending upon the Task Manager used, Begin( ) may return immediately after being called, performing the actual processing in a separate thread or threads. In this case, periodic callbacks to a progress function are made to inform the host application of the progress made for this particular output. The host can abort processing by returning an abort code from the progress callback function. When the output generation process is complete, a completion callback is made to the host application, possibly delivering any error codes that may have terminated the operation.

Most (but not necessarily all) output managers generate one or more files as their output. FileOutput, a subclass of PanoramaOutput, is the parent for these managers. It exists simply to store and convert references to output files and to abstract basic I/O operations. FileOutput can handle file references in several ways, including the ubiquitous file path identifiers and FSSpec records as used by the QuickTime API. A file can be referenced using either of these methods, and an output manager can retrieve the file reference transparently as either a path or an FSSpec. The implementation of FileOutput varies slightly between platforms. It can use POSIX-style I/O operations for compliant host platforms, Mac OS (HFS) calls, or Windows calls. FileOutput provides a thin shell over basic file operations (create, delete, read and write) to allow greater platform independence in the output manager classes that use it.

ImageFileOutput converts a CImage buffer in memory into an image file in one of many common output formats, including JPEG, TIFF, and PNG. ImageFileOutput can use the QuickTime API to provide its major functionality. This allows PhotoWarp to support a vast and expanding number of image file formats (more than a dozen) without requiring specialized code. ImageFileOutput supports any of the standard image file projections for output files, including equirectangular, cylindrical, or perspective. Equiangular output is also possible.

QTVROutput is an abstract class used as the basis for two QuickTime VR file formats. It exists to handle operations on the meta data used by QuickTime VR, including rendering and compression quality, pan/tilt/zoom constraints and defaults, and fast-start previews.

QTVRCylinderOutput uses the QTVRCylindricalPano projection to create standard QuickTime VR movies. The VR movies are suitable for embedding in web pages or distribution on CD-ROMs, etc. Both vertical and horizontal image orientations are supported. Vertical orientation is required for panoramas which must be viewed using QuickTime 3 and above. QTVRCubicOutput uses 6 QTVRPerspectivePano projections to generate the orthogonal faces of a cube. This encoding is much more efficient than cylinders for panoramas with large vertical fields of view. This can provide the ability to combine two reflective mirror format images (or a reflective mirror image and a fisheye image) to provide a full spherical panorama in the Cubic format.

MetaOutput does not actually define any image projection. Rather, MetaOutput is used to generate or manipulate text files with meta information about other outputs. The most common use of this output is to automatically generate HTML files which embed a QuickTime VR panorama. MetaOutput has definitions of the common embedding formats. It can create web pages with text or thumbnail links to other pages containing panoramas, or web pages with embedded flat image files, QuickTime VR panoramas, or panoramas with a platform-independent Java viewer such as PTViewer. MetaOutput also has an input component. It is able to parse a file (typically HTML) and embed an output within it based on meta tags following a certain structure. This allows web pages to be generated with custom interfaces to match a web site or integrate with a server. Custom web template functionality is implemented through this class.

Much of the platform-dependent nature of the Output Managers relate to asynchronous or preemptive processing. There is no cross-platform API to support the different threading implementations on various platforms. As a result, the Task Manager layer was created to parallel the Output Managers. Task Managers are responsible for initializing, restoring, running or destroying threads in a platform independent manner.

The synchronous RemapTaskManager provides a platform-independent synchronous fallback for processing. This is used in circumstances when preemptive multithreading is not available on a host platform (for example, the classic Mac OS without multiprocessing library). When the synchronous manager is used, the Begin( ) function in the OutputManager( ) will not return until the output processing has completed. Progress and completion callbacks will still be made, so the use of the synchronous manager should be transparent to the application.

Asynchronous task managers are defined for each major host platform for PhotoWarp. The MacRemapTaskManager and WinRemapTaskManager functions implement asynchronous functionality. The task manager uses the platform's native threading model to create a thread for each processor on the machine. Progress and completion callbacks are made either periodically or as chunks of data are processed. These callbacks are executed from the main application thread, so callbacks do not need to be reentrant or MP-safe.

One final abstraction layer separates the PhotoWarp Core from the user interface. The Job Processor is the main interface between the Core and the interface of an application. The interface does not need any specific knowledge of the Core and its implementation to operate other than the interface provided by the Job Processor. Likewise, the Core only needs to understand the Job abstraction to work with any host application. The Job abstraction is written in ANSI C, rather than C++. This implementation was chosen to allow the entire PhotoWarp Core to be built as a shared or dynamically linked library (DLL). This shelters the implementation of the Core from the Interface, and vice-versa. This also allows several alternative Interface layers to be written without having redundant Core code to maintain. For example, Interface implementations can be built using Mac OS Carbon APIs, Mac OS OSA (for AppleScript), Windows COM, and a platform-independent command-line interface suitable for a server-side application.

The Job preferably operates using an object-oriented structure implemented in C using private data structures. An Interface issues commands and retrieves responses from the core by constructing a Job and populating that Job with various structures which represent a collection of job items to be completed in a batch. These structures are built using constructors and mutators. The structures are referenced using pointer-sized arguments called JIDRefs.

The creation of a basic job can now be described. First, a main job reference is created. An input is typically a single image. For example, the input can be an image shot with a reflective mirror optic. This is a user-defined function that defines the necessary information for an input. A source is the source used to generate a destination. It is conceptually a set of inputs. The input is then added to the source. If multiple inputs are required to image a panorama, all inputs are added to the source. An output typically represents a single “file”. The output can be a QuickTime VR panorama. The output can also be a low resolution “thumbnail” image that can be used as a link on a web page. A destination is a set of outputs. Several outputs can be added to the same destination. They will both share the same source to generate their images. The source and destination are paired into a single item to be processed. Callback procedures are provided to indicate progress or completion.

Jobs are constructed by putting together different pieces to define the job as a whole. This is a many-to-many relationship. Any number of inputs can be combined as a single source, producing one or more destinations which themselves can contain any number of outputs. Splitting job construction in this manner makes constructing complex or lengthy jobs efficient. Batch processing is simply a matter of adding more job items (Source-Destination pairs) to the job prior to calling JobBegin( ). The code can also install some other fundamental data structures into the inputs and outputs. Options (identified by an OptionsIDRef function) define the specific parameters for a given input or output. The files used by an input or output are identified using a URIIDRef function, which currently holds a path to a local file as a uniform resource identifier. This construct allows the implementation of network file I/O functions (for example, to retrieve an image from a remote host or store output on a remote web server).

The Job Processor itself has a rudimentary capability for constructing and processing jobs that requires no user interface. XML files can be used to describe any job. Once a job has been constructed using the method described above, it can be exported to standard XML text using a JobConvertToXML( ) call. This functionality is useful for debugging, since it provides a complete description on how to reproduce a job exactly. The XML interface can be an ideal solution to a server-side implementation of the PhotoWarp Core. An interface can be built using web or Java tools, then submitted to a server for processing. The XML file could easily be subdivided and sent to another processing server in an “unwarping farm.”

The Interface layer is the part of the PhotoWarp application visible to the user. It shelters the user from the complexity of the underlying Core, while providing an easy to use, attractive front end for their utility. PhotoWarp can provide a simple one-window interface suitable for unwarping images shot with a reflective mirror optic one at a time. Specifically, PhotoWarp enables the following capabilities:

Open images shot using an equi-angular optic

Locate the optic in the image frame using a click-and-drag operation

Setting basic output options:

Output format: QTVR Cylinder, QTVR Cubic, Cylindrical Image, Spherical (Equirectangular) Image

Web template: None, generic, user-defined

Display size (for QuickTime VR formats)

Resolution

Compression quality

Unwarping the image

The implementation of the interface layer varies by platform. The appearance of the interface is similar on all platforms to allow easy switching between platforms for our users. Further, specialty interfaces can be provided for specific purposes. An OSA interface on the Mac OS, can allow the construction of jobs directly using the Mac's Open Scripting Architecture. OSA is most commonly used by AppleScript, a scripting language which is popular in production workflows in the publishing industry, among others.

While particular embodiments of this invention have been described above for purposes of illustration, it will be evident to those skilled in the art that numerous variations of the details of the present invention may be made without departing from the invention as defined in the appended claims.

1. A method of processing images, the method comprising the steps of:
retrieving a source image file including pixel data;
creating a destination image file buffer;
mapping the pixel data from the source image file to the destination image file buffer; and
outputting the pixel data from the destination image file buffer as a destination image file.

2. A method according to claim 1, wherein the step of mapping pixel data from the source image file to the destination image file buffer comprises the steps of:
defining a first set of coordinates of pixels in the destination image file;
defining a second set of coordinates of pixels in the source image file;
identifying coordinates of the second set that correspond to coordinates of the first set;
inserting pixel data for pixel locations corresponding the first set of coordinates into pixel locations corresponding to the second set of coordinates.

3. A method according to claim 2, wherein the first set of coordinates are spherical coordinates and the second set of coordinates are rectangular coordinates.

4. A method according to claim 1, further comprising the step of:
adding border pixel data to the source image file.

5. A method according to claim 1, wherein the step of mapping the pixel data from the source image file to the destination image file buffer includes the step of:
interpolating the source image pixel data to produce pixel data for the destination image file buffer.

6. A method according to claim 1, wherein the source image file includes pixel data from a plurality of images, and the step of mapping pixel data from the source image file to the destination image file buffer comprises the steps of:
sequentially mapping pixel data from the plurality of images to the destination image file buffer.

7. A method according to claim 1, wherein the source image file comprises duplicated pixel data corresponding to pixels in an overlapping region of an image.

8. A method according to claim 1, wherein the pixel data in the source image file includes opacity data.

9. A method according to claim 1, wherein source image file comprises a panoramic projection image file.

10. A method according to claim 1, wherein destination image file comprises one of: a cylindrical panoramic projection image file, a perspective panoramic projection image file, an equirectangular panoramic projection image file, and an equiangular panoramic projection image file.

11. A method according to claim 1, wherein the step of mapping the pixel data from the source image file to the destination image file buffer includes the step of:
creating a job function that controls the mapping step.

12. An apparatus for processing images, the apparatus comprising:
means for receiving a source image file including pixel data;
a processor for creating a destination image file buffer, for mapping the pixel data from the source image file to the destination image file buffer, and for outputting pixel data from the destination image file buffer as a destination image file; and
means for displaying an image defined by the destination file.

13. An apparatus according to claim 12, wherein the processor further serves as means for:
defining a first set of coordinates of pixels in the destination image file;
defining a second set of coordinates of pixels in the source image file;
identifying coordinates of the second set that correspond to coordinates of the first set;
inserting pixel data for pixel locations corresponding the first set of coordinates into pixel locations corresponding to the second set of coordinates.

14. An apparatus according to claim 13, wherein the first set of coordinates are spherical coordinates and the second set of coordinates are rectangular coordinates.

15. An apparatus according to claim 12, wherein source image file includes:
border pixel data.

16. An apparatus according to claim 15, wherein source image pixel data for each pixel includes opacity information.

17. An apparatus according to claim 12, wherein the processor further serves as means for:
interpolating the source image pixel data to produce pixel data for the destination image file buffer.

18. An apparatus according to claim 12, wherein source image file comprises a panoramic projection image file.

19. An apparatus according to claim 12, wherein destination image file comprises one of: a cylindrical panoramic projection image file, a perspective panoramic projection image file, an equirectangular panoramic projection image file, and an equiangular panoramic projection image file.
